(19) United States
(12) Patent Application Publication
(10) Pub. No.: US 2006/0197269 A1
(43) Pub. Date: Sep. 7, 2006

(54) Drawer clamp

(76) Inventors: Curtis W. Downey, Dothan, AL (US); Bobby L. Wood, Butler, AL (US)

Correspondence Address: John Wiley Horton, Attorney;Pennington, Moore, Wilkinson, Bell & Dunbar, P.A., P. O. Box 10095, Tallahassee, FL, 32302-2095, US

(21) Appl. No.: 11/072,105

(22) Filed: Mar. 4, 2005

(51) Int. Cl. B25B 5/14

(52) U.S. Cl. 269/111

(57) ABSTRACT

A new clamp for woodworking. The clamp features two parallel clamp rails joined at each end by connecting members. The movement of sliding clamps along the clamp rails is coordinated by a bracing member which connects the sliding clamps together and provides a clamping surface.

### BACKGROUND OF THE INVENTION

1. Field of the Invention

This invention relates to the field of wood-working. More specifically, the invention comprises a woodworking framework clamp which can be used to fabricate drawers and the like.

2. Description of the Related Art

Clamps are widely used in the fabrication of drawers and in many other woodworking applications. It is often necessary in these applications to hold four members together as a frame as they are fastened together by wood glue, nails, screws, staples, disks, or dowels. This is often accomplished by using a single clamp or combination of clamps to provide force to the assembled frame from four different directions.

Numerous clamps are used in the prior art to supply force to the sides of a drawer as the members are fastened together. Examples of prior art clamps include those described in U.S. Pat. Nos. 2,619,136; 4,132,396; 2,753,902; and 4,027,866. Although these clamps function to hold a drawer frame together as the members are fastened together, they are cumbersome or inefficient in practice. Many prior art clamps come in multiple pieces which can become separated or lost. Other prior art clamps provide long threaded screws and wing nuts as a means of tightening the clamp around the frame. These threaded-screw clamps often require the user to turn multiple wing nuts for many revolutions until the corner brackets of the clamp can engage the members of the frame. Even more, many of these clamps are ineffective in ensuring a square relationship between the members of the frame when the drawer is clamped therebetween.

It is therefore the purpose of the present invention to provide a woodworking clamp that overcomes the problems with the prior art clamps and is efficient and easy to use.

### BRIEF SUMMARY OF THE INVENTION

The present invention comprises a woodworking clamp that can be used for the fabrication of drawers and the like. The clamp features two parallel clamp rails joined at each end by connecting members. A preferred embodiment of the present invention includes a sliding clamp attached to each rail. The sliding clamps operate in unison, and their movement along to the clamp rail is coordinated by a bracing member which adjoins the two clamps.

### BRIEF DESCRIPTION OF THE SEVERAL VIEWS OF THE DRAWINGS

FIG. 1 is a perspective view, showing the preferred embodiment of the present invention

FIG. 2 is a perspective view, showing the preferred embodiment of the present invention clamped around a drawer.

FIG. 3 is a perspective view, showing the clamp mechanism.

FIG. 4 is a top view, showing the clamp bracket.

FIG. 5 is a perspective view, showing an alternate clamping mechanism.

FIG. 6 is a perspective view, showing an alternate clamping mechanism.

FIG. 7 is a perspective view, showing an alternate clamping mechanism.

FIG. 8A is a perspective view, showing an alternate embodiment of the clamp rail.

FIG. 8B is a perspective view, showing an alternate embodiment of the clamp rail.

FIG. 9 is a perspective view, showing an alternate embodiment of the present invention.

FIG. 10 is a perspective view, showing an alternate embodiment of the present invention.

### REFERENCE NUMERALS IN THE DRAWINGS

10 drawer clamp

12 clamp rail

14 connecting member

16 sliding clamp

18 bracing member

20 face plate

22 connecting bracket

24 drawer

26 drawer frame

28 drawer base

30 handle

32 threaded shank

34 clamp bracket

36 bracing bracket

38 non-threaded shank

40 orifice

42 orifice

44 joint

46 threaded orifice

48 rail orifice

50 notches

52 ridges

54 gripping bracket

56 handle

58 ratcheting lever

60 spring toggle

62 screw tightener

### DESCRIPTION OF THE INVENTION

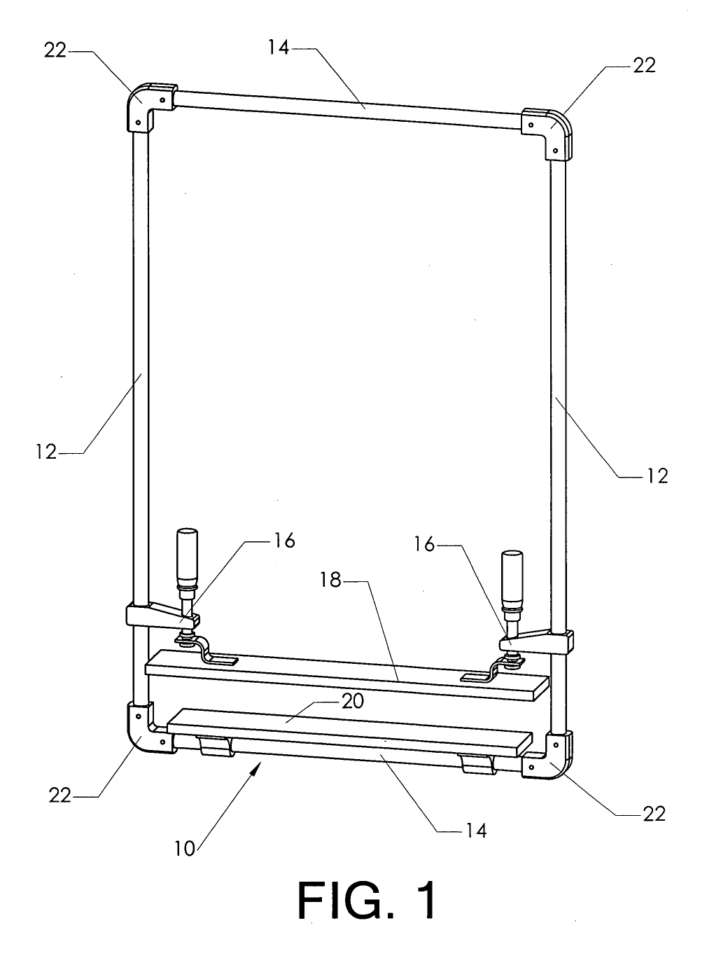

A detailed illustration of the preferred embodiment of the present invention is shown in FIG. 1. Drawer clamp 10 is provided with two clamp rails 12. Clamp rail 12 is illustrated in FIG. 1 as a cylindrical metal rod with a circular cross section. Clamp rail 12, however, can be made of other materials such as wood or plastic, and can have non-circular cross sections including rectangular, elliptical, and I-shaped cross sections. Connecting members 14 maintain clamp rails 12 in parallel position and attach to the rails at each end. Connecting members 14 are metal rods with circular cross sections in FIG. 1, but other materials and cross sections can also be used.

Connecting brackets 22 are used in the preferred embodiment to connect the ends of connecting members 14 to the ends of clamp rails 12. Connecting members 22 help maintain a perpendicular relationship between connecting members 14 and clamp rails 12, thereby ensuring that clamp rails 12 remain parallel.

A sliding clamp 16 is connected to each clamp rail 12. Bracing member 18 is connected to both sliding clamps 16, thereby coordinating the movement of the clamps along clamp rails 12. Bracing member 18 also functions as a clamping surface used to supply force to objects being fastened together as later illustrated and described. In the preferred embodiment face plate 20 is attached to connecting member 14 in a direction parallel to and facing bracing member 18. Face plate 20 also functions as a clamping surface.

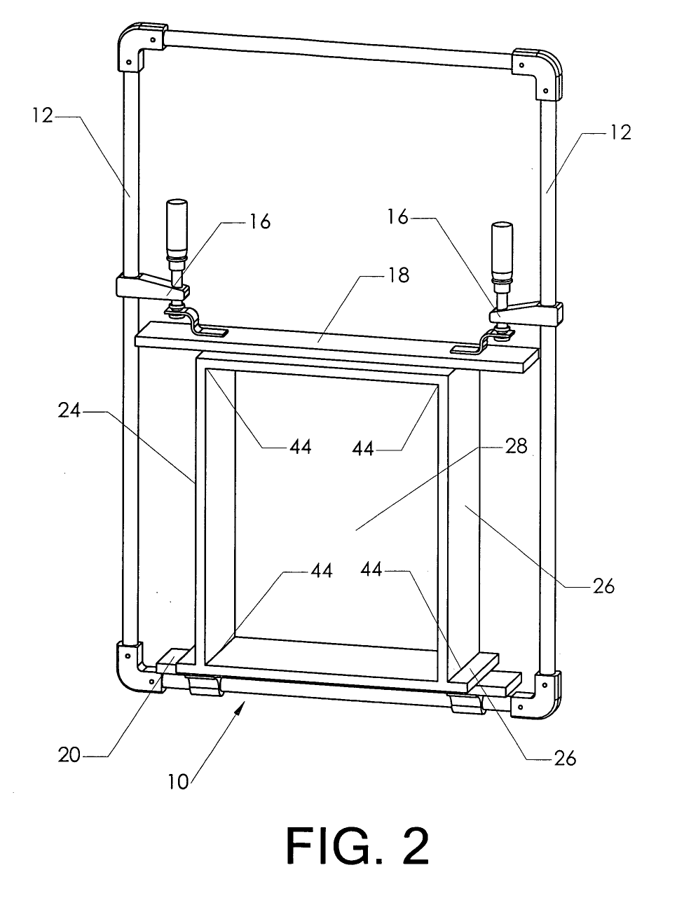

FIG. 2 illustrates how the present invention is used to clamp a drawer during fabrication. Drawer clamp 10 operates to supply clamping force to drawer frame 26 as the pieces are fastened together. Drawer 24 is assembled between bracing member 18 and face plate 20. Drawers are commonly assembled by adjoining four frame members together forming drawer frame 26 and drawer base 28.

Many methods can be used to fasten the members of the frame together. One common method of fabrication involves the use of wood glue or a combination of wood glue and dowels or discs as a fastening means. If wood glue is used, the user can dispense wood glue along joints 44 in drawer frame 26. The glued drawer can be placed between face plate 20 and bracing member 18. Bracing member 18 can be slid down clamp rail 12 by sliding the clamps until contact is made with drawer frame 26. Since wood glue creates its tightest bond when it dries under compression, sliding clamps 16 can then be used to tighten bracing member 18 and front plate 20 around the assembly so as to supply compressive force to the frame members. Force is supplied to the drawer by the clamp using a levered-clamping means which is described later. The drawer is then retained in the clamp until the glue dries.

Other methods of fabrication involve the use of other means of attachment such as screws, nails, and staples. The drawer clamp can be used in these methods to provide a means of alignment of the drawer frame as the frame members are attached together. The user can assemble the frame between bracing member 18 and face plate 20, and then bring bracing member 18 into contact with drawer frame 26. The frame members can then be adjusted into alignment and sliding clamps 16 can be used to provide clamping force to drawer frame 26 as the frame is nailed, screwed, or stapled together.

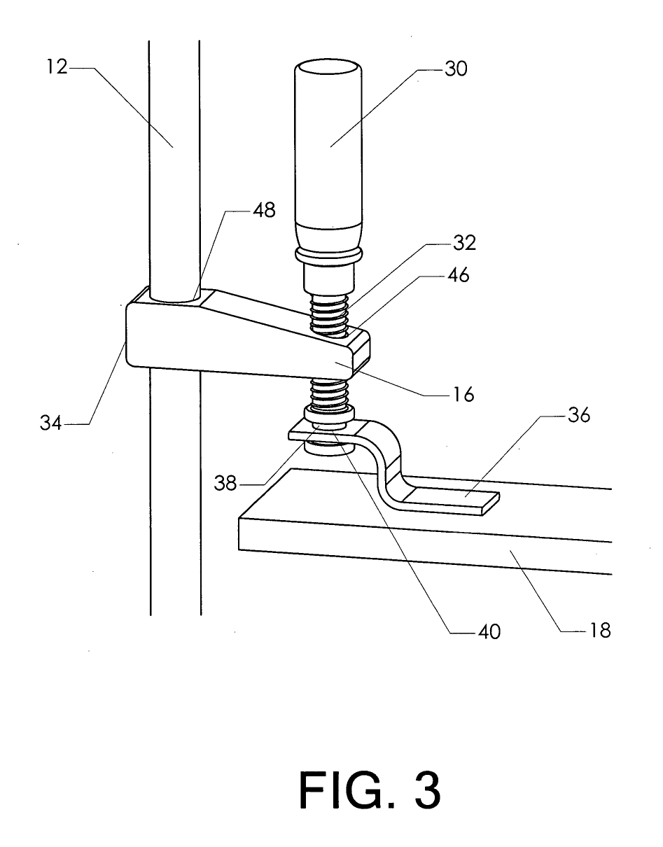

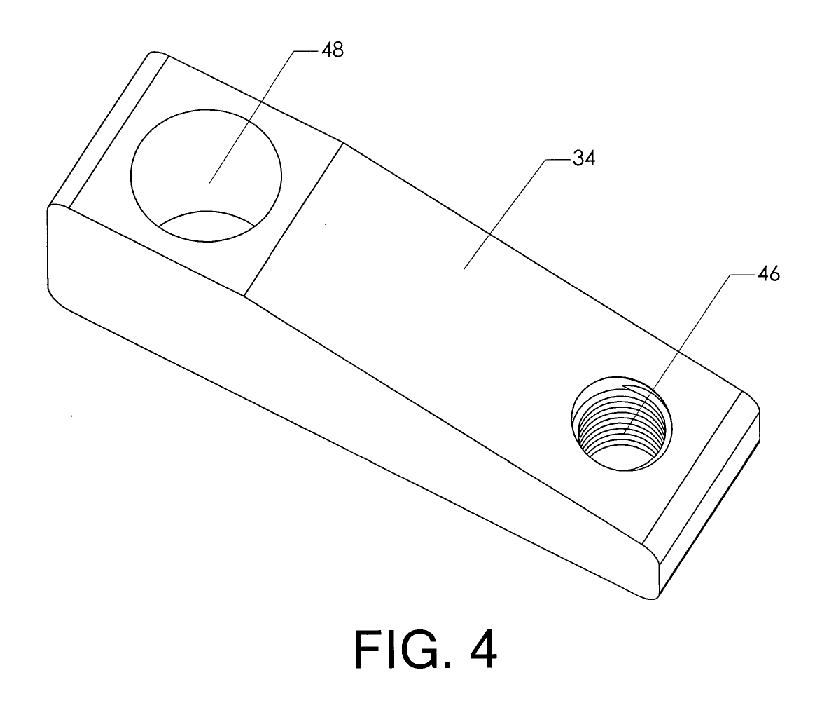

A detailed view of a preferred embodiment of the sliding clamp mechanism is shown in FIG. 3. Bracing bracket 36 is attached to bracing member 18. Bracing bracket 36 has orifice 40 which is sized to receive non-threaded shank 38 of sliding clamp 16. Threaded shank 32 is fed through threaded orifice 46 of clamp bracket 34. Clamp bracket 34 has rail orifice 48 through which clamp rail 12 passes, thereby facilitating slidable engagement of clamp bracket 34 with clamp rail 12. FIG. 4 shows a top view of clamp bracket 34 with rail orifice 48 and threaded orifice 46 for clearer illustration.

With reference to FIG. 3, the clamp is tightened by turning handle 30. Those skilled in the art will understand that rotation of handle 30 of sliding clamp 16 will increase the distance between clamp bracket 34 and bracing member 18. Clamp bracket 34 operates as a lever when handle 30 is turned and creates a pinch-point between rail orifice 48 and clamp rail 12 as bracing member 18 is compressed against the drawer. This lever action prevents the translational movement of clamp bracket 34 vis-à-vis clamp rail 12.

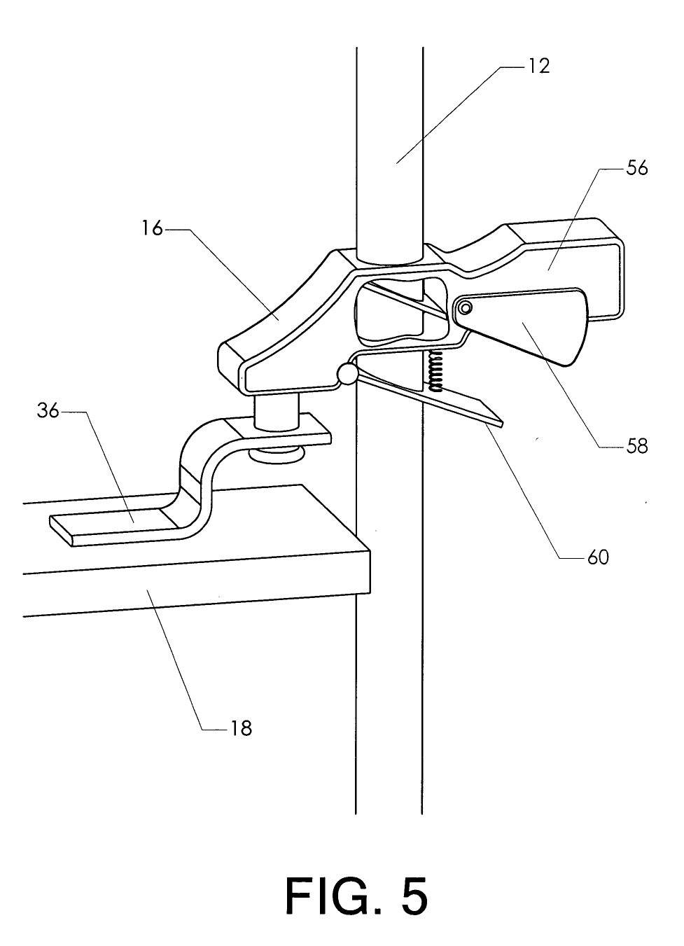

Other sliding clamp mechanisms can be used to accomplish a similar levered-clamping action. FIG. 5 shows a modified sliding clamp. Sliding clamp 16 features spring toggle 60 and ratcheting lever 58 for improved gripping of clamp rail 12 by sliding clamp 16. The user operates the clamp by squeezing spring toggle 60 towards handle 56 and sliding sliding clamp 16 down clamp rail 12 until bracing member 18 comes in contact with the object to be clamped. Spring toggle 60 has an orifice (not shown) through which clamp rail 12 passes such that sliding clamp 16 can slide freely along clamp rail 12 when spring toggle 60 is depressed but will not slide when spring toggle 60 is released because of friction between spring toggle 60 and clamp rail 12. The user can then squeeze ratcheting lever 58 towards handle 56, thereby tightening the clamp around the object to be clamped.

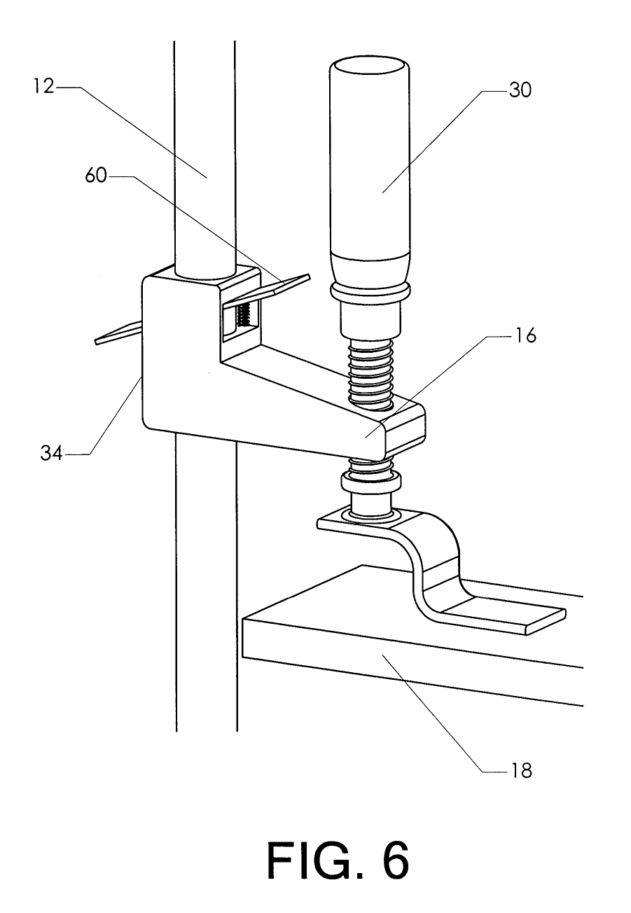

FIG. 6 shows the sliding clamp of FIG. 3 featuring a spring toggle. Spring toggle 60 can be added to any sliding clamp to improve the grip of clamp bracket 34 with respect to clamp rail 12. The spring toggle of the embodiment shown in FIG. 5 operates the same as spring toggle 60 in FIG. 4.

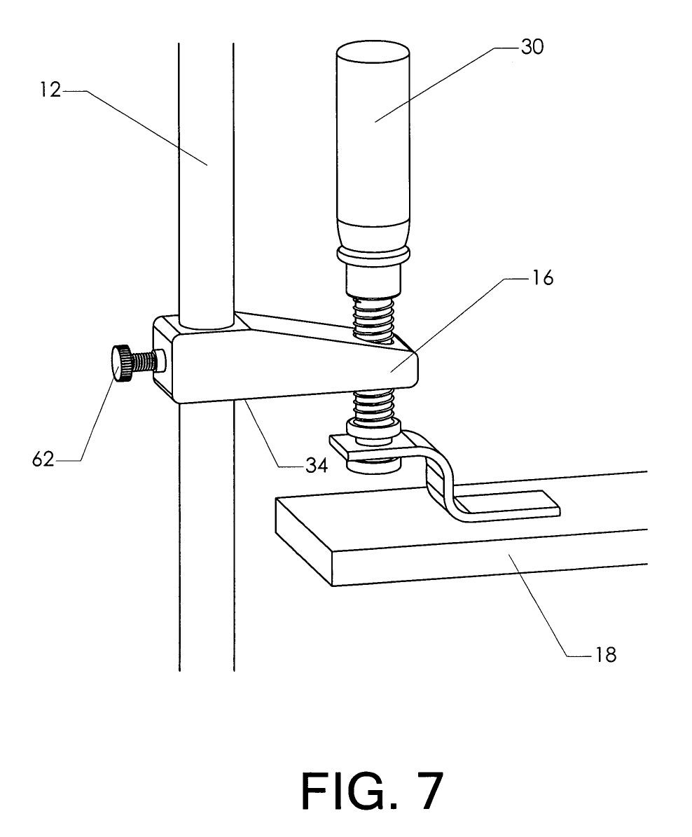

FIG. 7 shows the sliding clamp of FIG. 3 featuring a screw tightener. Like spring toggle 60, screw tightener 62 can be added to any sliding clamp to improve the grip of clamp bracket 34 with respect to clamp rail 12. When screw tightener 62 is rotated, screw tightener 62 bears against clamp rail 12, thereby increasing the frictional force between clamp rail 12 and clamp bracket 34 and screw tightener 62 and preventing the translational movement of clamp bracket 34 vis-à-vis clamp rail 12.

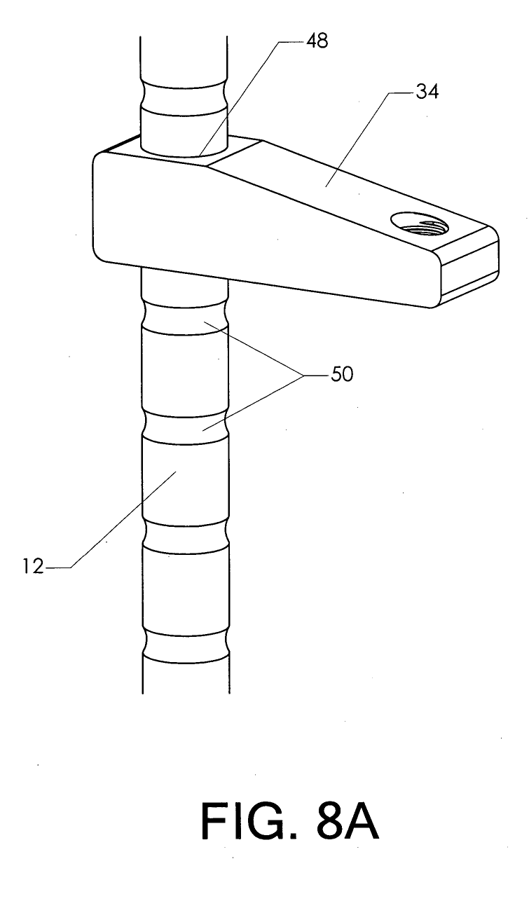

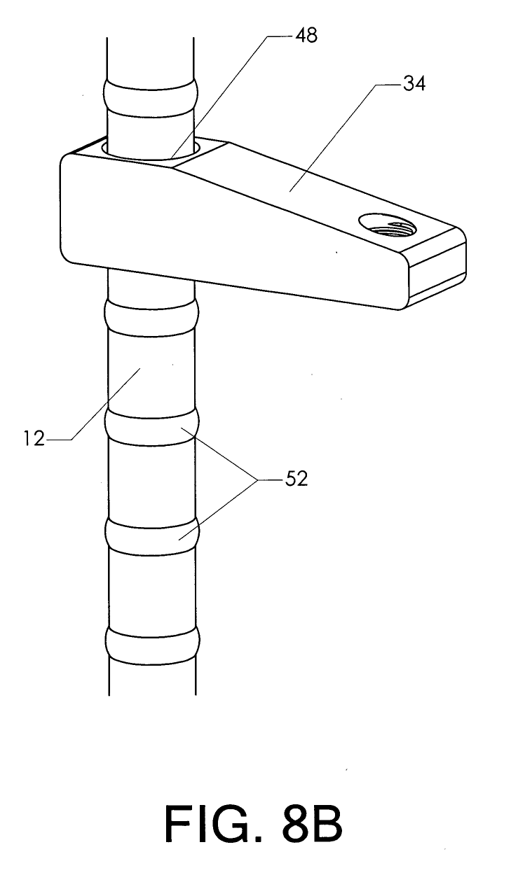

In addition, clamp rails 12 can be altered to improve the levered-clamping action. Alternate embodiments of the clamp rail are shown in FIGS. 8A and 8B. FIG. 8A shows clamp rail 12 enhanced with notches 50. This treatment to the surface of clamp rail 12 can improve its “gripability” by providing a surface that is closer to perpendicular with respect to rail orifice 48 when the levered-clamping action causes rail orifice 48 to mate with clamp rail 12. A similar effect can be created by enhancing the surface of clamp rail 12 with ridges 52 as illustrated in FIG. 8B.

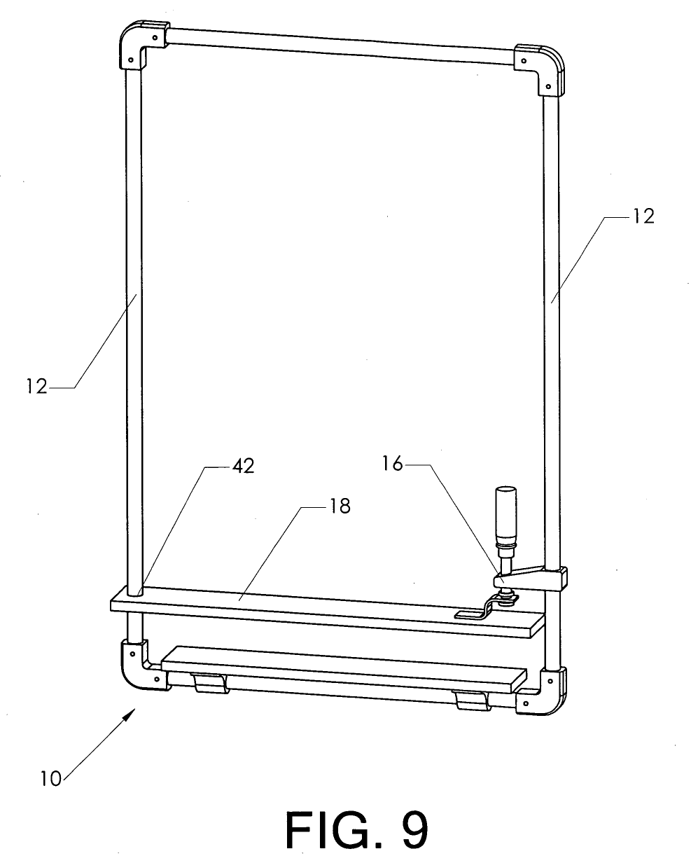

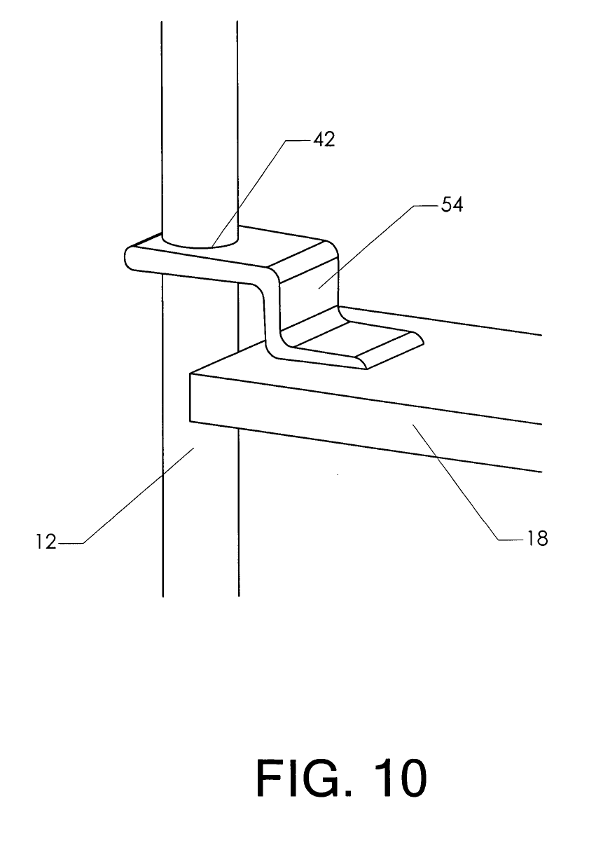

An alternate embodiment of the invention is shown in FIG. 9. The alternate embodiment features only one sliding clamp 16 instead of two. In the place of the second sliding clamp, elongated bracing member 18 with orifice 42 is provided to engage clamp rail 12. Similarly, as illustrated in FIG. 10, gripping bracket 54 with orifice 42 can also be used in place of the second sliding clamp to engage clamp rail 12. In both of these embodiments clamping force is provided by turning single sliding clamp 16.

Although the preceding description contains significant detail, it should not be construed as limiting the scope of the invention but rather as providing illustrations of the preferred embodiments of the invention. As an example, drawer clamp 10 is not solely for the fabrication of drawers and wordworking but can instead be used for any application where such a clamp is needed.

Having herein described my invention, I claim:

1. A drawer clamp comprising:
a. a first clamp rail, having a first end and a second end;
b. a second clamp rail, having a first end and a second end, said second clamp rail substantially parallel to said first clamp rail;
c. a first connecting member, said first connecting member connecting said first end of said first clamp rail to said first end of said second clamp rail;
d. a second connecting member, said second connecting member connecting said second end of said first clamp rail to said second end of said second clamp rail;
e. a first sliding clamp attached to said first clamp rail;
f. a first slidable connection between said first sliding clamp and said first clamp rail, lockable in position;
g. a bracing member, having a first end and a second end;
h. a screw tightener, said screw tightener attaching said first end of said bracing member to said first sliding clamp; and
i. a second slidable connection between said second end of said bracing member and said second clamp rail.

2. The drawer clamp of claim 1, further comprising a second sliding clamp attached to said second sliding rail, wherein said second sliding clamp further comprises a screw tightener attaching said second sliding clamp to said second end of said bracing member.

3. The drawer clamp of claim 1, wherein said first connecting member further comprises a face plate, said face plate substantially parallel to said bracing member.

4. The drawer clamp of claim 2, wherein said first connecting member further comprises a face plate, said face plate substantially parallel to said bracing member.

5. The drawer clamp of claim 1, wherein said first sliding clamp further comprises:
a. a clamp bracket, said clamp bracket slidably connected to and around said first clamp rail; and
b. a threaded shank, said threaded shank threadedly connected to said clamp bracket.

6. The drawer clamp of claim 2, wherein said first sliding clamp further comprises:
a. a clamp bracket, said clamp bracket slidably connected to and around said first clamp rail; and
b. a threaded shank, said threaded shank threadedly connected to said clamp bracket.

7. The drawer clamp of claim 6, wherein said second sliding clamp further comprises:
a. a clamp bracket, said clamp bracket slidably connected to and around said second clamp rail; and
b. a threaded shank, said threaded shank threadedly connected to said clamp bracket.

8. The drawer clamp of claim 5, wherein said threaded shank of said first sliding clamp has a top portion and a bottom portion, wherein said bottom portion of said threaded shank is on the side of said clamp bracket proximal to said bracing member and said top portion of said threaded shank is on the side of said clamp bracket distal to said bracing member, said first sliding clamp further comprises a nonthreaded shank attached to said bottom portion of said threaded shank, and wherein said bracing member is attached to said first sliding clamp with a bracing bracket, said bracing bracket having a first end and a second end, said first end of said bracing bracket attached to said bracing member, and said second end attached to said nonthreaded shank of said first sliding clamp.

9. The drawer clamp of claim 6, wherein said threaded shank of said first sliding clamp has a top portion and a bottom portion, wherein said bottom portion of said threaded shank is on the side of said clamp bracket proximal to said bracing member and said top portion of said threaded shank is on the side of said clamp bracket distal to said bracing member, said first sliding clamp further comprises a nonthreaded shank attached to said bottom portion of said threaded shank, and wherein said bracing member is attached to said first sliding clamp with a bracing bracket, said bracing bracket having a first end and a second end, said first end of said bracing bracket attached to said bracing member, and said second end attached to said nonthreaded shank of said first sliding clamp.

10. The drawer clamp of claim 9, wherein said threaded shank of said second sliding clamp has a top portion and a bottom portion, wherein said bottom portion of said threaded shank is on the side of said clamp bracket proximal to said bracing member and said top portion of said threaded shank is on the side of said clamp bracket distal to said bracing member, said first sliding clamp further comprises a nonthreaded shank attached to said bottom portion of said threaded shank, and wherein said bracing member is attached to said second sliding clamp with a bracing bracket, said bracing bracket having a first end and a second end, said first end of said bracing bracket attached to said bracing member, and said second end attached to said nonthreaded shank of said second sliding clamp.

11. The drawer clamp of claim 1, wherein said first sliding clamp further comprises a spring toggle.

12. The drawer clamp of claim 2, wherein said first sliding clamp further comprises a spring toggle.

13. The drawer clamp of claim 5, wherein said first sliding clamp further comprises a spring toggle.

14. The drawer clamp of claim 6, wherein said first sliding clamp further comprises a spring toggle.

15. The drawer clamp of claim 1, wherein said first sliding clamp further comprises:
a. a handle;
b. a ratcheting lever, said ratcheting lever positioned proximate to said handle; and
c. wherein a user can squeeze said ratcheting lever in the direction of said handle and thereby cause said first sliding clamp to move incrementally with respect to said first clamp rail.

16. The drawer clamp of claim 2, wherein said first sliding clamp further comprises:
a. a handle;
b. a ratcheting lever, said ratcheting lever positioned proximate to said handle; and
c. wherein movement of said ratcheting lever in the direction of said handle causes said first sliding clamp to move incrementally with respect to said first clamp rail.

17. The drawer clamp of claim 16, wherein said second sliding clamp further comprises:
a. a handle;
b. a ratcheting lever, said ratcheting lever positioned proximate to said handle; and
c. wherein movement of ratcheting lever in the direction of said handle causes said second sliding clamp to move incrementally with respect to said second clamp rail.

18. The drawer clamp of claim 1, wherein said first sliding clamp further comprises a screw tightener.

19. A drawer clamp comprising:
a. a first clamp rail, having a first end and a second end;
b. a second clamp rail, having a first end and a second end, said second clamp rail substantially parallel to said first clamp rail;
c. a connecting member, said connecting member connecting said first end of said first clamp rail to said first end said second clamp rail;
d. a sliding clamp means, said sliding clamp means slidably connected to said first clamp rail;
e. a bracing member, having a first end and a second end;
f. wherein said first end of said bracing member is operatively connected to said first clamp rail with said sliding clamp means; and
g. wherein said second end of said bracing member is operatively connected to said second clamp rail.
